(19) United States
(12) Patent Application Publication
(10) Pub. No.: US 2024/0385852 A1
(43) Pub. Date: Nov. 21, 2024

(54) METHOD OF WAKING UP OPERATING SYSTEM, APPARATUS, ELECTRONIC DEVICE AND STORAGE MEDIUM

(71) Applicant: GUANGDONG OPPO MOBILE TELECOMMUNICATIONS CORP., LTD., Dongguan (CN)

(72) Inventors: Junping KANG, Dongguan (CN); Zhaojin WANG, Dongguan (CN); Haiyun TANG, Dongguan (CN)

(73) Assignee: GUANGDONG OPPO MOBILE TELECOMMUNICATIONS CORP., LTD., Dongguan (CN)

(21) Appl. No.: 18/786,065

(22) Filed: Jul. 26, 2024

Related U.S. Application Data
(63) Continuation of application No. PCT/CN2022/139601, filed on Dec. 16, 2022.

(30) Foreign Application Priority Data
Jan. 28, 2022 (CN) 202210106666.X

(51) Int. Cl. G06F 9/4401

(52) U.S. Cl. CPC G06F 9/4418

(57) ABSTRACT

Embodiments of the present application relate to the technical field of electronic devices, and disclose a wake-up method and apparatus for an operating system, an electronic device, and a storage medium. The method is applied in an electronic device, the electronic device can run a first operating system and a second operating system, and the method comprises: when the first operating system and/or the second operating system are in a dormant state, if a target wake-up module generates a wake-up signal, controlling a target operating system corresponding to the target wake-up module to switch from the dormant state to a running state according to the wake-up signal. By implementing an embodiment of the present application, an electronic device can be automatically switched to an optimal operating system, and the degree of intelligence of the electronic device is improved.

### CROSS REFERENCE TO RELATED APPLICATIONS

The present application is a continuation application of the international patent application No. PCT/CN2022/139601, filed on Dec. 16, 2022, which claims priority of the Chinese patent application No. 202210106666.X, filed on Jan. 28, 2022, the contents of which are incorporated herein by reference in their entireties.

### TECHNICAL FIELD

The present disclosure relates to the field of electronic devices, and in particular to a method of waking up an operating system, an apparatus, an electronic device, and a storage medium.

### BACKGROUND

In the art, a plurality of operating systems may be installed in one electronic device. The plurality of operating systems may be used to perform different events, such that computing and processing capabilities of the electronic device may be improved.

In practice, for the electronic device in the art, switching between the plurality of operating systems may be achieved manually by a user, and intelligence of the electronic device may be poor.

### SUMMARY OF THE DISCLOSURE

The present application disclose provides a method and an apparatus of waking up an operating system, an electronic device, and a storage medium, in which the electronic device may automatically switch to an optimal operating system, and the intelligence of the electronic device may be improved.

In a first aspect, the present disclosure provides a method of waking up an operating system, performed by an electronic device. The electronic device is configured to run a first operating system and a second operating system. The method includes:
in a case where the first operating system and/or the second operating system are in a sleeping state, controlling, by the electronic device, a target operating system corresponding to a target wake-up module to switch from the sleeping state to a running state based on a wake-up signal; wherein the target wake-up module generates the wake-up signal.

In a second aspect, the present disclosure provides an apparatus of waking up an operating system, configured in an electronic device. The electronic device is configured to run a first operating system and a second operating system, and the apparatus includes:

a wake-up unit, in a case where the first operating system and/or the second operating system are in a sleeping state, configured to control a target operating system corresponding to a target wake-up module to switch from the sleeping state to a running state based on a wake-up signal; wherein the target wake-up module generates the wake-up signal.

In a third aspect, the present disclosure provides an electronic device, including:
a memory storing executable program codes;
a processor coupled to the memory.

The processor is configured to invoke the executable program codes stored in the memory to perform the method according to the first aspect.

In a fourth aspect, the present disclosure provides a computer-readable storage medium storing a computer program. The computer program causes a computer to perform the method of waking up the operating system in the first aspect.

In a fifth aspect, the present disclosure provides a computer program product. When the computer program product is run on a computer, the computer is caused to perform some or all of operations of the method in the first aspect.

In a sixth aspect, the present disclosure provides an application releasing platform. The application releasing platform is configured to release a computer program product. The computer program product, when running on a computer, causes the computer to perform some or all of operations of the method of the first aspect.

### BRIEF DESCRIPTION OF THE DRAWINGS

In order to more clearly illustrate the technical solutions in the embodiments of the present disclosure, the accompanying drawings for describing the embodiments will be introduced briefly in the following. Obviously, the accompanying drawings in the following description show only some of the embodiments of the present disclosure, and any ordinary skilled person in the art may obtain other attachments based on the accompanying drawings without any creative work.

FIG. 1 is a structural schematic view of an electronic device having a plurality of operating systems according to an embodiment of the present disclosure.

FIG. 2 is a flow chart of a method of waking an operating system according to an embodiment of the present disclosure.

FIG. 3 is a flow chart of another method of waking an operating system according to an embodiment of the present disclosure.

FIG. 4 is a timing diagram according to an embodiment of the present disclosure.

FIG. 5 is another timing diagram according to an embodiment of the present disclosure.

FIG. 6 is still another timing diagram according to an embodiment of the present disclosure.

FIG. 7 is a flow chart of still another method of waking an operating system according to an embodiment of the present disclosure.

FIG. 8 is a structural schematic view of an apparatus of waking an operating system according to an embodiment of the present disclosure.

FIG. 9 is a structural schematic view of an electronic device according to an embodiment of the present disclosure.

### DETAILED DESCRIPTION

Technical solutions in embodiments of the present disclosure will be described below by referring to the accompanying drawings of the embodiments of the present disclosure. Apparently, the described embodiments are a part of but not all of the embodiments of the present disclosure. All other embodiments, which are obtained by any ordinary skilled person in the art based on the embodiments in the present disclosure without making creative work, shall fall within the scope of the present disclosure.

To be noted that the terms “include”, “have” and any variations thereof in the embodiments of the present disclosure are intended to cover non-exclusive inclusion. For example, a process, a method, a system, a product or an apparatus including a series of steps or units need not be limited to those steps or units that are clearly listed, but may include other steps or units that are not clearly listed or inherently included in the process, the method, the system, the product or the apparatus. In addition, the terms “first”, “second”, “third”, and “fourth” in the embodiments are used to distinguish between different objects and are not used to describe a particular order.

Embodiments of the present disclosure provide a method and an apparatus of waking up an operating system, an electronic device, and a storage medium, in which the electronic device may automatically switch to an optimal operating system, and the intelligence of the electronic device may be improved.

Technical solutions will be described in detail by referring to specific embodiments.

In order to more clearly illustrate the method and the apparatus device of waking up the operating system, the electronic device, and the storage medium, an application scenario in which the method of waking up the operating system may be applied will be firstly introduced. In some embodiments, the method may be applied to an electronic device capable of running a plurality of operating systems. The electronic device includes, but not limited to, a portable device such as a mobile phones and a tablet computer, a wearable device such as a smart watch and a smart bracelet, and a desktop device such as a television and a desktop computer, which will not be limited herein.

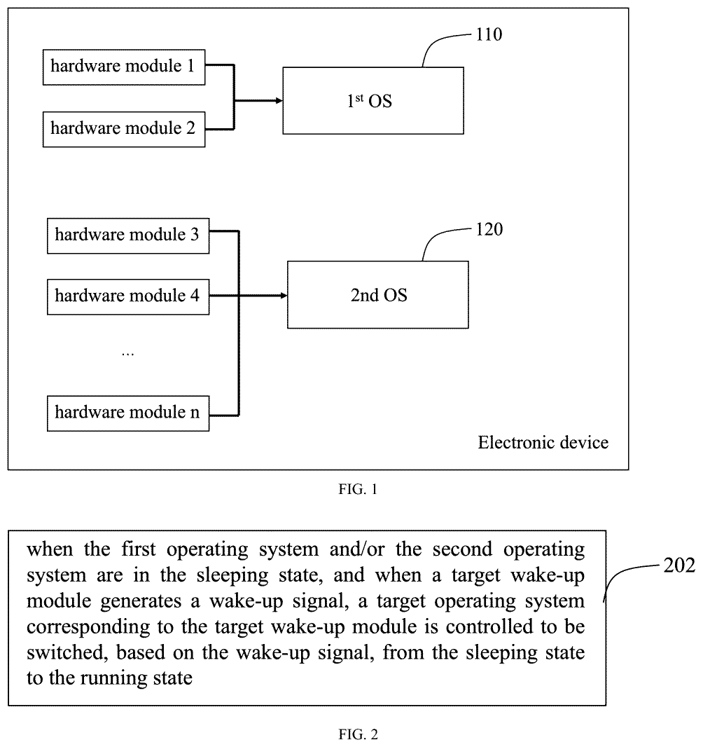

As shown in FIG. 1, FIG. 1 is a structural schematic view of an electronic device having a plurality of operating systems according to an embodiment of the present disclosure. The electronic device may include a plurality (two and more) of different operating systems, and FIG. 1 illustrates two operating systems as an example only (i.e., a first operating system 110 and a second operating system 120), which shall not limit the present disclosure.

It is understood that the first operating system 110 and the second operating system 120 may have different computing and processing capabilities and power consumptions. In some embodiments, the first operating system 110 may include, but is not limited to, the Android (Android) operating system, the Linux operating system. The second operating system 120 may include, but is not limited to, the Real Time Operating System (RTOS), the Windows operating system. Further, the electronic device may include one or more hardware modules. The hardware modules may include, but not limited to, buttons, a touch screen, and sensors. In some embodiments, some of the hardware modules may still be in a running state when the operating system is in a sleeping state. The hardware modules in the running state may generate a wake-up signal when a wake-up condition is met, and the wake-up signal may control a corresponding operating system to be switched from the sleeping state to the running state. For example, the touch screen corresponds to the first operating system, and the first operating system is in the sleeping state. In this case, when the touch screen detects a touch signal, the touch screen may generate the wake-up signal to wake up the first operating system by the wake-up signal.

The electronic device may configure one or more hardware modules as a wake-up module for each operating system to automatically wake up the corresponding operating system through the wake-up signal generated by the wake-up module. The user does not need to perform operations to manually switch between the operating systems, such that the intelligence of the electronic device is improved.

In some embodiments, the wake-up module corresponding to the operating system may be flexibly configured by the electronic device or the user according to demands, which is not limited herein. To be noted that, in an example, a hardware module 1 and a hardware module 2 in FIG. 1 are configured as wake-up modules for the first operating system 110, and a hardware module 3, a hardware module 4 . . . and a hardware module n are configured as wake-up modules for the second operating system 120, which shall not limit the present disclosure.

Accordingly, the method of waking up the operating system in the embodiments of the present disclosure will be described in the following.

As shown in FIG. 2, FIG. 2 is a flow chart of the method of waking the operating system according to an embodiment of the present disclosure. The method of waking up the operating system may be applied to the electronic device described above. The electronic device may run at least the first operating system and the second operating system. The method includes the following blocks.

In a block 202, in a case that the first operating system and/or the second operating system are in the sleeping state, and a target operating system corresponding to a target wake-up module is controlled to be switched, based on a wake-up signal, from the sleeping state to the running state. The wake-up signal is generated by the target wake-up module.

In some embodiments, the electronic device may include a plurality of different operating systems, such as 2, 3, or 4 operating systems, which is not limited herein. It is understood that in order to facilitate illustration of the method of waking up the operating system in the embodiments of the present disclosure, the embodiments are illustrated by taking two operating systems as an example (i.e., the first operating system and the second operating system), which shall not limit the present disclosure.

In some embodiments, the target operating system corresponding to the target wake-up module may be the first operating system or the second operating system. When the target wake-up module is configured, in advance, as the wake-up module of the first operating system, the target operating system is the first operating system. Similarly, when the target wake-up module is configured, in advance, as the wake-up module of the second operating system, the target operating system is the second operating system. The target wake-up module may be a display screen, a keypad, or any sensor arranged in the electronic device, which is not limited herein.

In the sleeping state, in a case that a battery power level of the electronic device is not consumed, only essential functions of the operating system are running, functions of the operating system other than the essential functions are all shut down, and the operating system is able to be woken up in time to switch from the sleeping state to the running state. The essential functions may include, but are not limited to, a function of receiving the wake-up signal, a function of saving system data, and the like.

In the art, when the operating system is in the sleeping state, the user may need to manually wake up the operating system, such that an operating system desired by the user is switched on. In this way, a switching process is complicated, and the intelligence of the electronic device is poor.

In some embodiments, the electronic device may configure the wake-up module for each operating system correspondingly. The wake-up module may generate the wake-up signal when the wake-up condition is met, and the corresponding operating system is controlled to switch from the sleeping state to the running state based on the wake-up signal. The user does not need to manually switch between the operating systems, such that the intelligence of the electronic device is improved. In some embodiments, the wake-up module may determine, in response to detecting a target event trigger, that the wake-up module meets the wake-up condition. For example, a modem module may determine that the modem module meets the wake-up condition in response to detecting a call event trigger. The touch screen may determine that the touch screen meets the wake-up condition in response to detecting a touch event trigger. Detailed wake-up condition will not be limited herein.

According to the method in the above embodiments, in the case that the first operating system and/or the second operating system is in the sleeping state, the target operating system corresponding to the target wake-up module is controlled to be switched, based on the wake-up signal, from the sleeping state to the running state, and the wake-up signal is generated by the target wake-up module. In other words, according to the embodiments of the present disclosure, the electronic device may automatically switch to the operating system corresponding to the target wake-up module, without requiring the user to manually perform the switching, such that the intelligence of the electronic device is improved. In addition, in the embodiments of the present disclosure, the process of waking up and switching the operating system is performed automatically at a background of the electronic device. The user does not sense the switching between the operating systems, such that senseless switching is achieved, and a user experience is improved.

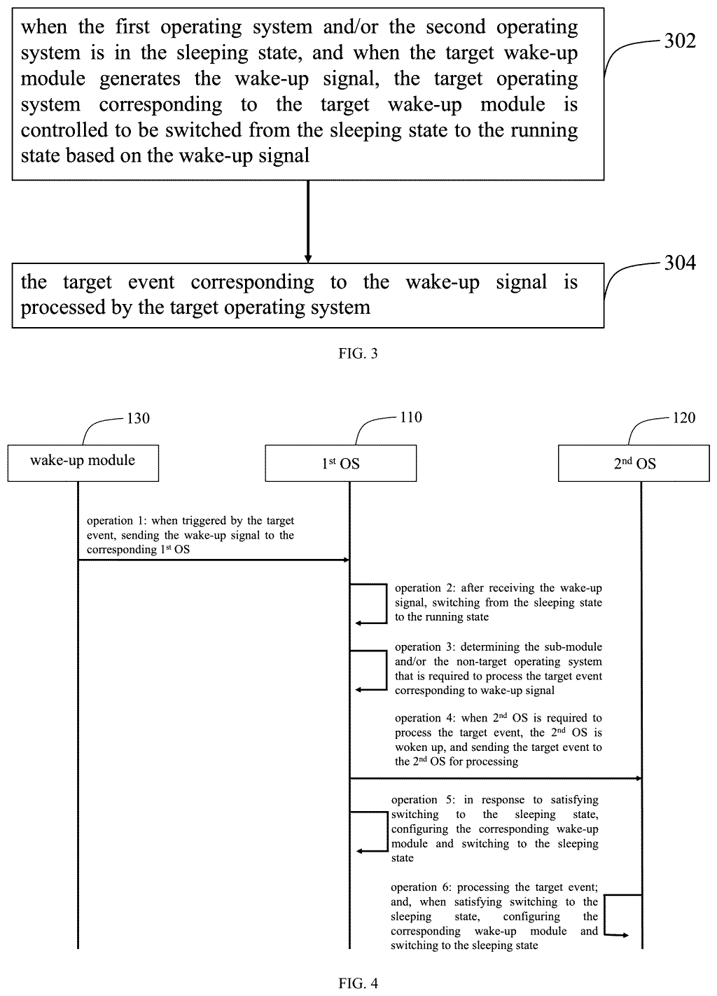

As shown in FIG. 3, FIG. 3 is a flow chart of another method of waking the operating system according to an embodiment of the present disclosure. The method of waking up the operating system is applied to the electronic device described above. The electronic device may run at least the first operating system and the second operating system. The method may includes following blocks.

In a block 302, in the case that the first operating system and/or the second operating system is in the sleeping state, the target operating system corresponding to the target wake-up module is controlled to be switched from the sleeping state to the running state based on the wake-up signal, and the wake-up signal is generated by the target wake-up module.

In some embodiments, the target operating system corresponding to the target wake-up module may be configured by the electronic device or by the user. In some embodiments, the target operating system may be an optimal operating system for processing a target event. The target event is an event that triggers the target wake-up module to generate the wake-up signal. The optimal operating system is an operating system that has a processing effect on the target event greater than an effect threshold. The processing effect includes a processing quality and/or a processing effect. In this regard, a subsequent target operating system that is woken up may process the target event to improve the processing effect on the target event.

In some embodiments, the target operating system may be determined based on a system selection instruction entered by the user. The system selection instruction includes either the first operating system or the second operating system.

For example, in a case that the system selection instruction includes the first operating system, the first operating system may be served as the target operating system corresponding to the target wake-up module.

In another embodiment, the target operating system may be an operating system determined, from the first operating system and the second operating system, by the electronic device according to a matching rule. The matching rule includes the operating system corresponding to each wake-up module. For example, the touch screen corresponds to the first operating system, the keypad correspond to the second operating system, and so on, which will not be limited herein. Further, in the example, when the target wake-up module is the touch screen, the electronic device may take the first operating system as the target operating system; and when the target wake-up module is the keypad, the electronic device may take the second operating system as the target operating system.

To be further noted that, one target wake-up module usually corresponds to only one target operating system, so as to prevent, after one target wake-up module generating the wake-up signal, conflicts due to a plurality of target operating systems corresponding to one target wake-up module running at the same time. In some embodiments, one target operating system may correspond to N target wake-up modules. Further, when M target wake-up modules of the N target wake-up modules generate wake-up signals, the target operating system may switch from the sleeping state to the running state. The N is a positive integer, and the M is a positive integer less than or equal to N.

In a block 304, the target event corresponding to the wake-up signal is processed by the target operating system.

In some embodiments, the target event may refer to various functional tasks that can be processed by the electronic device. The target event includes, but not limited to: a telephone call event, an alarm clock event, a keypad-typing event, a touch event, and so on. When a trigger of the target event is detected by the wake-up module, the wake-up module may generate the corresponding wake-up signal.

As described above, the target operating system that is woken up is usually the optimal operating system for processing the target event corresponding to the wake-up signal. Therefore, after the target operating system is switched from the sleeping state to the running state, the target event corresponding to the wake-up signal is processed by the target operating system in order to improve the processing effect on the target event.

In some embodiments, during the target operating system processing the target event, other sub-modules or a non-target operating system in the electronic device may need to process the target event cooperatively with the target operating system. For example, when the target operating system is processing the alarm clock event, a loud speaker module is required to output a prompting audio. In another example, when the target operating system is processing the telephone call event, the non-target operating system has an authority to answer the telephone call, and therefore, the target operating system may send the telephone call event to the non-target operating system for processing.

In this regard, in an embodiment, the target operating system may determine the sub-module and/or the non-target operating system that is required to process the target event corresponding to the wake-up signal. The non-target operating system may be one of the first operating system and the second operating system, other than the target operating system. For example, when the target operating system is the first operating system, the non-target operating system is the second operating system; and when the target operating system is the second operating system, the non-target operating system is the first operating system. The sub-module may be a hardware module that is installed in the electronic device and is used to process the target event, such as the display screen, a loud speaker, or any sensor, which will not be limited herein.

Further, the target operating system may send the target event to the sub-module and/or the non-target operating system to cause the sub-module and/or the non-target operating system to process the target event.

According to the above method, the other sub-modules or the non-target operating system required for processing the target event may be further determined, enabling the target event to be processed by a more matching and more specialized module or operating system. In this way, it is ensured that the target event is processed in time, and the processing effect on the target event is improved.

In an embodiment, when the target operating system determines that the target event needs to be processed by the non-target operating system and the non-target operating system is in the sleeping state, the target operating system sends a running instruction to the non-target operating system, such that the non-target operating system is switched from the sleeping state to the running state after receiving the running instruction.

In some embodiments, a data transmission link may be established between the target operating system and the non-target operating system, such that the target operating system sends the running instruction to the non-target operating system via the data transmission link. In another embodiment, the target operating system and the non-target operating system may transmit other data or instructions to each other via the data transmission link, which will not be limited herein.

According to the above method, when the non-target operating system is required to process the target event, the target operating system directly triggers the non-target operating system in the sleeping state to switch to the running state to process the target event, without requiring the user to manually perform the switching, such that the intelligence of the electronic device is improved.

In another embodiment, when it is determined that the non-target operating system is satisfied with switching to the sleeping state, the non-target operating system may determine at least one shared module, from all shared modules in the electronic device, to be configured as a wake-up module corresponding to the non-target operating system, and the non-target operating system is controlled to switch to the sleeping state. The shared module is a module that serves as the wake-up module for the first operating system or the second operating system.

In some embodiments, when it is determined that the non-target operating system is in an idle state for a first time length (the first time length may be set by a developer based on a large amount of development data, and a typical value may be 30 seconds, 50 seconds, and so on, which is not limited herein), it is determined that the non-target operating system meets a situation of switching to the sleeping state. The idle state refers to a state in which the non-target operating system is not processing the target event.

In another embodiment, when it is determined that any first association module associated with the non-target operating system is in a non-operating state, it is determined that the non-target operating system meets the condition of switching to the sleeping state. The first association module is a module that needs to be controlled by the non-target operating system, and the non-operating state includes the sleeping state and a shutdown state.

According to the above method, the non-target operating system may automatically configure the wake-up module for itself when the non-target operating system is about to enter the sleeping state. In this way, subsequently, the non-target operating system may automatically switch to the running state according to the wake-up signal generated by the wake-up module without requiring the user to manually wake up the non-target operating system or manually perform the switching. Therefore, the intelligence of the electronic device is improved.

In some embodiments, the electronic device may further include one or more public peripheral apparatuses including, but not limited to, a display apparatus, the loud speaker, the keypad, and so on, which is not limited herein.

It is understood that since the electronic device includes the plurality of operating systems, in order to prevent conflicts due to the plurality of operating systems controlling a same peripheral apparatus at the same time, the operating system needs to have a control authority for the peripheral apparatus in order to control the peripheral apparatus. In this regard, the target operating system may switch the control authority for the peripheral apparatus from one operating system to another operating system, such that the target operating system may process the target event based on the peripheral apparatus.

In some embodiments, when both the target operating system and the non-target operating system are in the sleeping state before the target operating system corresponding to the target wake-up module is controlled to be switched from the sleeping state to the running state based on the wake-up signal, neither the target operating system nor the non-target operating system has the control authority for the peripheral apparatus. In this case, the control authority for the peripheral apparatus may be directly configured to the target operating system.

In another embodiment, before the target operating system corresponding to the target wake-up module is controlled to be switched from the sleeping state to the running state based on the wake-up signal, the non-target operating system is in the running state, and the non-target operating system has the control authority for the peripheral apparatus. In this case, the target operating system sends a switching instruction to the non-target operating system, and the non-target operating system may, based on the switching instruction, switch the control authority for the peripheral apparatus to the target operating system. In some embodiments, the non-target operating system may further switch the target operating system to running at a foreground of the electronic device based on the switching instruction.

According to the above method, the control authority for the peripheral apparatus of the electronic device is configured to the target operating system to enable the target operating system to assist in processing the target event through the peripheral device. In this way, the processing effect and a processing efficiency of the target event is improved. Furthermore, a control instruction sent by the target operating system to the peripheral apparatus may be prevented from conflicting with a control instruction sent by other operating systems, ensuring the electronic device to operate normally.

Further, after configuring the control authority of the peripheral apparatus of the electronic device to the target operating system, the target operating system may receive an input target operation via the peripheral apparatus (e.g., the keypad, the touch screen, or a sound acquisition apparatus), such that the target operating system may process the input target operation.

For example, the target operating system may receive an input touch operation via the touch screen, and processes and responds to the touch operation. In another example, the target operating system may collect sound information via the sound acquisition apparatus, and then processes the sound information, which will not be limited herein.

In another embodiment, after configuring the control authority for the peripheral device of the electronic device to the target operating system, the target operating system may control the peripheral apparatus to perform a corresponding operation based on a processing result. The processing result is a result obtained by the target operating system processing the target event.

For example, the target operating system processes the alarm clock event and obtains a processing result in which the display screen needs to be switched to a screen-on state to display an alarm clock interface, and the loud speaker outputs a prompting audio. In this case, the target operating system may control the display screen to switch to the screen-on state to display the alarm clock interface and control the loud speaker to output the prompting audio.

According to the above method, after having the control authority for the peripheral apparatus, the electronic device may receive the operation input from the user or output the processing result through the peripheral apparatus. In this way, the target operating system may have the improved processing effect and processing efficiency of the target event with assistance of the peripheral apparatus.

In another embodiment, after configuring the control authority for the peripheral apparatus of the electronic device to the target operating system, the target operating system may receive a second processing result and control the peripheral apparatus to perform a corresponding operation according to the second processing result. The second processing result is a result obtained by the non-target operating system processing the target event.

The above describes a case in which the target operating system has the control authority for the peripheral apparatus. In some embodiments, before the target operating system corresponding to the target wake-up module is controlled to switch from the sleeping state to the running state based on the wake-up signal, the non-target operating system is already in the running state and has the control authority for the peripheral apparatus. In this case, the target operating system may send a peripheral control instruction to the non-target operating system, and the non-target operating system may control the peripheral apparatus to perform a corresponding operation based on the peripheral control instruction sent by the target operating system. The peripheral control instruction is obtained by the target operating system processing the target event.

For example, the target operating system processes the alarm clock event and obtains the processing result. The processing result includes the loud speaker outputting the prompting audio. In this case, the target operating system may generate a peripheral control instruction for the loud speaker and send the peripheral control instruction to the non-target operating system. The non-target operating system may control the loud speaker to output the prompting audio based on the peripheral control instruction.

According to the above method, when the target operating system is running at the background of the electronic device and does not have the control authority for the peripheral apparatus, the target operating system may send the processing result to the non-target operating system that is running at the foreground and has the control authority for the peripheral apparatus. In this way, the non-target operating system controls the peripheral apparatus to perform the corresponding operation according to the received processing result. Flexibility of the processing the target events in the electronic device is improved, and the processing efficiency of the target event is improved.

It is further noted that the target operating system processes the target event, the control authority for the peripheral apparatus is configured to the target operating system, or the target operating system is allowed to generate the peripheral control instruction to be sent to the non-target operating system that has the control authority of the peripheral apparatus, only when the obtained processing result requires the peripheral apparatus to be used. In some embodiments, when the obtained processing result does not require the peripheral apparatus to be used, the control authority for the peripheral apparatus may not be configured to the target operating system, in order to prevent the control authority for the peripheral apparatus from being switched frequently.

According to the above method, the operating system matching the target wake-up module may be automatically switched based on the target wake-up module without requiring the user to manually perform the switching, such that the intelligence of the electronic device is improved. In addition, in the embodiments of the present disclosure, the process of waking up the operating system and switching between the operating systems is automatically performed at the background of the electronic device, and the user has no sense for the switching between the operating systems, the senseless switching is achieved, the usage experience is improved. In addition, the other sub-modules or the non-targeted operating system required for processing the target event are further determined, so that the target event can be processed by a more matched and more specialized module or operating system. Therefore, the target event is processed in time, and the processing effect of the target event is improved. The control authority of the peripheral apparatus of the electronic device can be switched to the target operating system, enabling the target operating system to assist in processing the target event through the peripheral apparatus, such that the processing effect and the processing efficiency of the target event is improved. The control instructions sent by the target operating system to the peripheral apparatus are prevented from conflicting with instructions sent by the other operating systems, ensuring the electronic device to operate normally. After having the control authority of the peripheral apparatus, the electronic device may receive the operation input from the user or output the processing result through the peripheral apparatus, such that the target operating system may have the improved processing effect and the improved processing efficiency of the target event with the assistance of the peripheral apparatus.

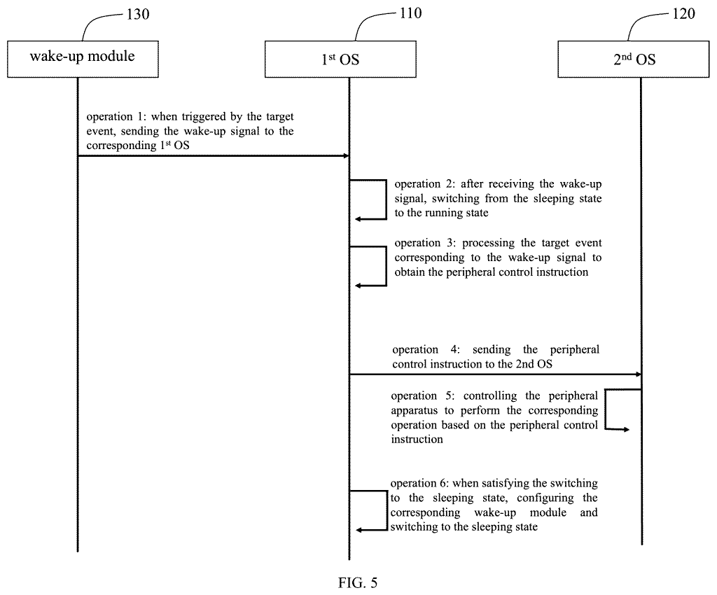

In order to more clearly illustrate the method of waking up the operating system disclosed in the embodiments, the method is described below base on a timing diagram in FIGS. 4 and 5. It is to be understood that FIGS. 4 and 5 are only examples made for the purpose of conveniently illustrating the method and shall not limit the present disclosure.

As shown in FIG. 4, FIG. 4 is a timing diagram according to an embodiment of the present disclosure. In this case, both the first operating system 110 and the second operating system 120 are in the sleeping state. In an operation 1, when the wake-up module 130 is triggered by the target event, the wake-up module 130 sends the wake-up signal to the corresponding first operating system 110. In an operation 2, the first operating system 110, after receiving the wake-up signal, switches from the sleeping state to the running state. In an operation 3, the first operating system 110 determines the sub-module and/or the non-target operating system that is required to process the target event corresponding to wake-up signal. In an operation 4, when the second operating system 120 is required to process the target event, the first operating system 110 wakes up the second operating system 120 and sends the target event to the second operating system 120 for processing. In an operation 5, the first operating system 110, in response to satisfying switching to the sleeping state, configures the corresponding wake-up module and switches to the sleeping state. In an operation 6, the second operating system 120 processes the target event; and, in response to satisfying switching to the sleeping state, the second operating system 120 configures the corresponding wake-up module and switches to the sleeping state.

As shown in FIG. 5, FIG. 5 is another timing diagram according to an embodiment of the present disclosure. In this case, the first operating system is in the sleeping state, and the second operating system is in the running state. In an operation 1, when the wake-up module 130 is triggered by the target event, the wake-up module 130 sends the wake-up signal to the corresponding first operating system 110. In an operation 2: the first operating system 110, after receiving the wake-up signal, switches from the sleeping state to the running state. In an operation 3: the first operating system 110 processes the target event corresponding to the wake-up signal to obtain the peripheral control instruction. In an operation 4: the first operating system 110 sends the peripheral control instruction to the second operating system 120. In an operation 5: the second operating system 120 controls the peripheral apparatus to perform the corresponding operation based on the peripheral control instruction. In an operation 6: the first operating system 110, in response to satisfying the switching to the sleeping state, configures the corresponding wake-up module and switches to the sleeping state.

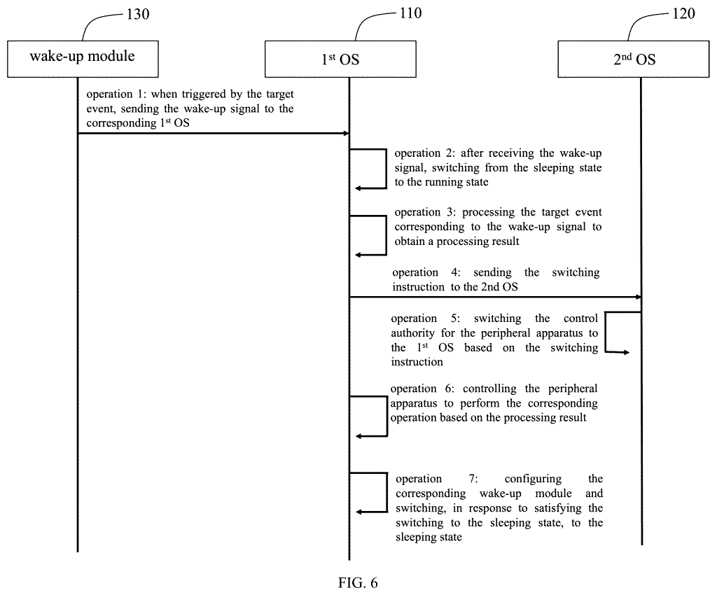

As shown in FIG. 6, FIG. 6 is still another timing diagram according to an embodiment of the present disclosure. In this case, the first operating system is in the sleeping state, and the second operating system is in the running state. In an operation 1, when the wake-up module 130 is triggered by the target event, the wake-up module 130 sends the wake-up signal to the corresponding first operating system 110. In an operation 2: the first operating system 110, after receiving the wake-up signal, switches from the sleeping state to the running state. In an operation 3, the first operating system 110 processes the target event corresponding to the wake-up signal to obtain the processing result. In an operation 4: the first operating system 110 sends the switching instruction to the second operating system 120. In an operation 5: the second operating system 120 switches the control authority for the peripheral apparatus to the first operating system 110 based on the switching instruction. In an operation 6: the first operating system 110 controls the peripheral apparatus to perform the corresponding operation based on the processing result. In an operation 7: the first operating system 110 configures the corresponding wake-up module and switches, in response to satisfying the switching to the sleeping state, to the sleeping state.

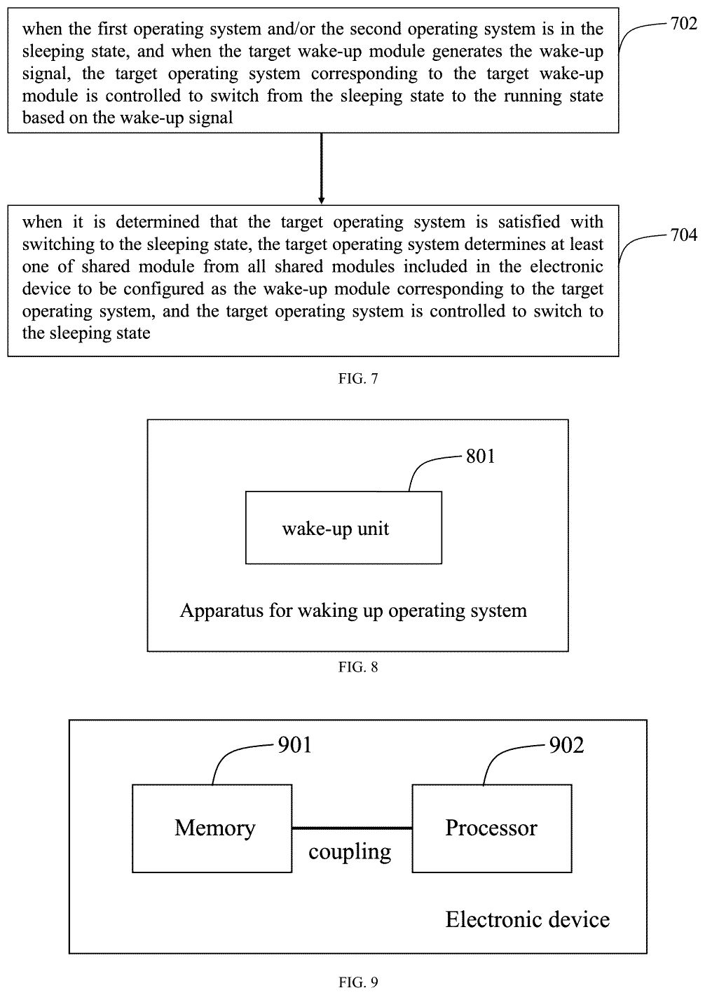

As shown in FIG. 7, FIG. 7 is a flow chart of still another method of waking an operating system according to an embodiment of the present disclosure.

The method of waking up the operating system may be applied to the electronic device described above. The electronic device may run at least the first operating system and the second operating system. The method may include the following blocks.

In a block 702, when the first operating system and/or the second operating system is in the sleeping state, and when the target wake-up module generates the wake-up signal, the target operating system corresponding to the target wake-up module is controlled to switch from the sleeping state to the running state based on the wake-up signal.

In an embodiment, after the target operating system corresponding to the target wake-up module is controlled to switch from the sleeping state to the operation state based on the wake-up signal, when the target operating system detects that the display apparatus of the electronic device is switched to a screen-off state, the target operating system is controlled to switch to the sleeping state.

In some embodiments, when the target operating system detects that the display apparatus of the electronic device is switched to the screen-off state and stays in the screen-off state for an screen-off time length, the target operating system is controlled to switch to the sleeping state.

In a case that the target operating system switches to the sleeping state immediately after the display apparatus is screen-off and the display apparatus is screen-on within a short period of time, which requires the target operating system to be switched to the running state again, the target operating system may be switched frequently in a short period of time. therefore, normal operation of the electronic device may be affected. Therefore, the first time length may be greater than 0 seconds, such as 10 seconds, 20 seconds, and so on, which is not limited herein. In this way, after the display apparatus is screen-off, a certain time length can be given to the electronic device, preventing the target operating system from being frequently switched in a short period of time.

In some embodiments, when the first operating system and/or the second operating system is in the sleeping state, a first wake-up signal generated by a first wake-up module for the target operating system is detected, and a second wake-up signal generated by a second wake-up module for the other operating system is detected. In this case, when an importance level corresponding to the first target event corresponding to the first wake-up signal is greater than an importance level corresponding to the second target event corresponding to the second wake-up signal, the target operating system is controlled to switch from the sleeping state to the running state based on the first wake-up signal. The other operating system is an operating system other than the target operating system from the first operating system and the second operating system.

When wake-up signal for different operating systems are received at the same time, the operating system having the higher importance level is woken up to process the target event having the higher importance level.

In a case, the first operating system and/or the second operating system is in the sleeping state, and a third wake-up signal generated by a shared wake-up module for the target operating system and a fourth wake-up signal generated by an exclusive wake-up module for the target operating system are detected. In this case, the target operating system is controlled to be switched from the sleeping state to the running state based on the fourth wake-up signal. The third wake-up signal generated by the shared wake-up module can wake up the target operating system or the other operating system. The other operating system is the operating system other than the target operating system in the first operating system and the second operating system. The fourth wake-up signal generated by the exclusive wake-up module can wake up only the target operating system.

According to the above method, the corresponding operating system can be woken up firstly according to the wake-up signal generated by the exclusive wake-up module, preventing the wake-up signal mistakenly generated by the shared wake-up module from waking up the target operating system incorrectly, such that a fault tolerance of the method is improved.

In a block 704, when it is determined that the target operating system is satisfied with switching to the sleeping state, the target operating system determines at least one of shared module from all shared modules included in the electronic device to be configured as the wake-up module corresponding to the target operating system, and the target operating system is controlled to switch to the sleeping state.

In some embodiments, when it is determined that the target operating system is in the idle state for a second time length (the second time length may be set by a developer based on a large amount of development data, having a typical value of 35 seconds, 45 seconds, and so on, which is not limited herein), it is determined that the target operating system is satisfied with the switching to the sleeping state. The idle state refers to a state in which the target operating system is not processing any target event.

In another embodiment, when it is determined that any second associated modules associated with the target operating system is in the non-operating state, it is determined that the target operating system is satisfied with switching to the sleeping state. The second associated module is a module that needs to be controlled by the target operating system, and the non-operating state includes the sleeping state and the shut down state.

In some embodiments, the electronic device includes a first exclusive module corresponding to the target operating system and/or a second exclusive module corresponding to the non-target operating system. A wake-up signal generated by the first exclusive module is used to wake up only the target operating system, and a wake-up signal generated by the second exclusive module is used to wake up only the non-target operating system. In some embodiments, the first exclusive module and the second exclusive module may wake up the corresponding operating module without being configured to the corresponding operating system.

In another embodiment, the electronic device may further include the shared module, the shared module is a module that is configured as the wake-up module for the first operating system or the second operating system. Therefore, the wake-up signal generated by the shared module is used to wake up the target operating system or the non-target operating system. In this regard, in order to avoid conflicts due to the target operating system and the non-target operating system being woken up at the same time, the shared module can be configured as the wake-up module corresponding to only one operating system when the operating system is about to enter the sleeping state, such that the wake-up signals generated by the shared module can be used to wake up only the corresponding operating system subsequently.

According to the above method, at least one shared module from all shared modules included in the electronic device can be determined to be configured as the wake-up module corresponding to the target operating system. The wake-up signal generated by the wake-up module subsequently is used to wake up only the target operating system. Therefore, conflicts, due to the plurality of operating systems being woken up at the same time by the wake-up signal generated by the shared wake-up module, may be prevented; and in addition, controllability and flexibility in controlling waking up the operating system is improved.

In an embodiment, the target operating system determines at least one shared module from all shared modules included in the electronic device, and configures the at least one shared module as the wake-up module to be effective for the target operating system.

It is understandable that the shared module, in addition to serving as the wake-up module, may further achieve other functions. For example, the touch screen serves as the wake-up module and can generate the wake-up signal when the touch event is detected; in addition, the touch screen serves as a window for the user to interact with the electronic device, achieving functions of displaying and touch control. In this regard, when the shared module is configured as a to-be-effected wake-up module for the target operating system, and when the to-be-effected wake-up module is still in the running state, a function that is currently executed by the to-be-effected wake-up module may conflict with the wake-up function, such that the target operating system may be woken up by mistake.

For example, the touch screen serves as the wake-up module and generates the wake-up signal when the touch event is detected. However, the touch screen may also detect the touch event when being controlled by another operating system to serve as an interaction window. Therefore, the target operating system is woken up mistakenly.

In this regard, the target operating system may determine that the to-be-effected wake-up module can be effective only when the to-be-effected wake-up module is determined as being in the idle state. The effected wake-up module is used to generate the wake-up signal to cause the target operating system to switch from the sleeping state to the running state based on the wake-up signal. The idle state refers to a state in which the to-be-effected wake-up module is not processing any task.

According to the above method, the target operating system may configure a corresponding wake-up module when the target operating system is about to enter the sleeping state and determines that the configuration is effective only when the configured wake-up module is being determined as being in the idle state. In this way, a function that is currently executed by the to-be-effected wake-up module is prevented from conflicting with the wake-up function, and the target operating system is prevented from being woken up mistakenly.

In another embodiment, the target operating system may determine that the to-be-effected wake-up module is effective only when both the target operating system and the non-target operating system are determined as being in the sleeping state.

It is to be noted that, when the operating system other than the target operating system does not enter the sleeping state, the other operating system, during operating, may also invoke the to-be-effected wake-up module, such that the to-be-effected wake-up module, when being invoked, may mistakenly generate the wake-up signal to wake up the target operating system. In this regard, the configured to-be-effected wake-up module is determined to be effective only when all operating systems included in the electronic device enter the sleeping state. In this way, the to-be-effected wake-up module, when being invoked, is prevented from mistakenly generating the wake-up signal to wake up the target operating system.

In an embodiment, an operating power consumption of the second operating system is less than an operating power consumption of the first operating system. In some embodiments, when the electronic device is currently in a first operating mode and the target operating system is the second operating system, the target operating system may configure all shared modules included in the electronic device as the wake-up modules corresponding to the target operating system.

In some embodiments, when the electronic device is currently in a second operating mode and the target operating system is the first operating system, the target operating system may configure all shared modules included in the electronic device as the wake-up modules corresponding to the target operating system. The operating power consumption when the electronic device is in the first operating mode is less than the operating power consumption when the electronic device is in the second operating mode.

In some embodiments, the first operating mode may include a low-power-consumption mode, and the second operating mode may include a high-performance mode.

It is understood that, when the electronic device is in the low-power-consumption mode, and when all hardware modules are configured as wake-up modules of the second operating system having the lower operating power consumption, the second operating system having the lower operating power consumption can be woken up when any of the wake-up modules generates the wake-up signal, such that demands for the electronic device running at the low power consumption are met. For example, the first operating system is the Android operating system, and the second operating system is the RTOS operating system. An operating power consumption of the RTOS operating system is less than an operating power consumption of the Android operating system.

When the electronic device is currently in the low-power-consumption mode, all hardware modules are configured as wake-up modules of the RTOS operating system. When any wake-up module generates the wake-up signal, the wake-up signal may wake up the RTOS operating system to process the target event, such that requirements of the electronic device running at the low operating power consumption are met.

According to the above method, when the electronic device is in the low-power-consumption mode, all hardware modules are configured as the wake-up modules for the operating system having the lower operating power consumption. Any wake-up module generating the wake-up signal may wake up the operating system having the lower operating power consumption, such that requirements of the electronic device running at the low operating power consumption are met.

In another embodiment, an operating performance of the first operating system may be higher than an operating performance of the second operating system. In some embodiments, when the electronic device is currently in a high-performance mode and the target operating system is the first operating system, all hardware modules included in the electronic device are configured as wake-up modules corresponding to the target operating system.

Similarly, when the electronic device is currently in the high-performance mode, and when all hardware modules are configured as wake-up modules of the first operating system having the high performance, the first operating system can be woken up when any wake-up module generates the wake-up signal, such that requirements of the electronic device running at the high performance are met.

According to the above method, when the electronic device is in the high-performance mode, all hardware modules are configured as wake-up modules of the operating system having the high performance. The high-performance operating system can be woken up to process the target event when any wake-up module generates the wake-up signal, such that requirements of the electronic device running at the high performance are met.

According to the above method, the operating system matching the target wake-up module can be automatically switched to run, without requiring the user to manually perform the switching, such that the intelligence of the electronic device is improved. In addition, in the present disclosure, the waking up and the switching processes of the operating systems are automatically performed at the background of the electronic device, the user has no sense for the switching between the operating systems, such that senseless switching is achieved, and the usage experience is improved. At least one hardware module may be determined among all hardware modules included in the electronic device to be configured as the wake-up module corresponding to the target operating system. The wake-up signal generated by the wake-up module may be used to wake up only the target operating system. Conflicts, due to the plurality of operating systems being woken up at the same time by the wake-up signal generated by the wake-up module, may be prevented, and controllability and flexibility in the control of the waking up the operating systems are improved.

The corresponding wake-up module may be configured when the electronic device is about to enter the sleeping state, and the configuration may be effective only when the configured to-be-effected wake-up module is in the idle state. The current function performed by the to-be-effected wake-up module is prevented from conflicting with the wake-up function, and the target operating system is prevented from being woken up mistakenly. When the electronic device is in the low-power-consumption mode, all hardware modules may be configured as wake-up modules of the operating system having the lower operating power consumption. When any wake-up module generates the wake-up signal, the wake-up signal wakes up the operating system having the lower operating power consumption to process the target event, such that the requirements for the electronic devices running at the lower operating power consumption are met. When the electronic device is in the high-performance mode, all hardware modules are configured as wake-up modules for the operating system having the high performance. When any subsequent wake-up module generates the wake-up signal, the wake-up signal wakes up the operating system having the high performance to process the target event, such that the requirements for the electronic devices running at the high performance are met.

As shown in FIG. 8, FIG. 8 is a structural schematic view of an apparatus of waking the operating system according to an embodiment of the present disclosure. The apparatus may be configured in the electronic device described above. The electronic device can run at least the first operating system and the second operating system, and the device includes a wake-up unit 801.

The wake-up unit 801 is configured to control the target operating system corresponding to the target wake-up module to switch from the sleeping state to the running state according to the wake-up signal in response to the target wake-up module generating the wake-up signal, in the case that the first operating system and/or the second operating system is in the sleeping state.

According to the above-described apparatus, when the target wake-up module generates the wake-up signal and when the first operating system and/or the second operating system is in the sleeping state, the apparatus controls the target operating system corresponding to the target wake-up module to be switched from the sleeping state to the running state according to the wake-up signal. That is, in the present embodiments, the electronic device may automatically switch to the operating system matching the target wake-up module according to the target wake-up module, without requiring the user to manually perform the switching, such that the intelligence of the electronic device is improved. In addition, in the present embodiments, the waking up and the operating system switching processes are performed automatically at the background of the electronic device, such that the user has no sense of the switching between the operating systems, and therefore, the senseless switching is achieved, and the usage experience is improved.

In an embodiment, the apparatus shown in FIG. 8 may further include a processing unit, which is not shown in the drawing.

The processing unit is configured to take, after controlling the target operating system corresponding to the target wake-up module to be switched from the sleeping state to the running state based on the wake-up signal, the target operating system to process the target event corresponding to the wake-up signal.

According to the above-described apparatus, the target operating system that is woken up is usually the optimal operating system for processing the target event corresponding to the wake-up signal. Therefore, after the target operating system is switched from the sleeping state to the running state, the target operating system processes the target event corresponding to the wake-up signal, improving the processing effect of the target event.

In an embodiment, the wake-up unit 801 is further configured to determine, via the target operating system, the sub-module and/or the non-target operating system required to process the target event corresponding to the wake-up signal. The non-target operating system is one of the first operating system and the second operating system, other than the target operating system. In addition, the wake-up unit 801 is further configured to send, via the target operating system, the target event to the sub-module and/or the non-target operating system to cause the sub-module and/or the non-target operating system to process the target event. The sub-module is a hardware module included in the electronic device capable of executing the target event.

According to the above-described apparatus, the other sub-module or the non-target operating system required for processing the target event are further determined, so as to enable the target event to be processed by a more matching and more specialized module or operating system. In this way, it is ensured that the target event is processed in time, and the processing effect of the target event is improved.

In an embodiment, the apparatus shown in FIG. 8 further includes a first sending unit, which is not shown in the drawing.

After determining the sub-module and/or the non-target operating system required for processing the target event corresponding to the wake-up signal, the first sending unit is configured to send, via the target operating system, the running instruction to the non-target operating system to cause the non-target operating system to switch from the sleeping state to the running state, in response to the target event being required to be processed by the non-target operating system and the non-target operating system being in the sleeping state.

According to the above-described apparatus, when the non-target operating system is required to process the target event, the target operating system may directly trigger the non-target operating system in the sleeping state to switch to the running state to process the target event without requiring the user to manually perform the switching, such that the intelligence of the electronic device is improved.

In an embodiment, the apparatus shown in FIG. 8 further includes a first configuration unit, which is not shown in the drawing.

After the target operating system sends the target event to the sub-module and/or the non-target operating system to cause the sub-module and/or the non-target operating system to process the target event, and in response to determining that the non-target operating system is satisfied with the switching to the sleeping state, the first configuration unit is configured to determine, via the non-target operating system, at least one shared module from all shared modules included in the electronic device to be configured as the wake-up module corresponding to the non-target operating system, and control the non-target operating system to switch to the sleeping state. The shared module is a module capable of being configured as the wake-up module of the first operating system or the second operating system.

According to the above-described apparatus, the non-targeted operating system can automatically configure the wake-up module for itself when the non-targeted operating system is about to enter the sleeping state, enabling the non-targeted operating system to automatically switch to the running state based on the wake-up signal generated by the wake-up module without requiring the user to manually perform the waking up or the switching process. Therefore, the intelligence of the electronic device is improved.

In an embodiment, the apparatus shown in FIG. 8 further includes a second sending unit, which is not shown in the drawing.

After the target operating system processes the target event corresponding to the wake-up signal, and in response to the non-target operating system being in the running state and having the control authority for the peripheral apparatus, the second sending unit is configured to send the peripheral control instruction to the non-target operating system through the target operating system. The peripheral control instruction is obtained by the target operating system processing the target event, and the non-target operating system is one of the first operating system and the second operating system, other than the target operating system.

According to the above-described apparatus, when the target operating system is running at the background of the electronic device and does not have the control authority of the peripheral apparatus, the target operating system may send the processing result to the non-target operating system that is running at the foreground and has the control authority of the peripheral apparatus, causing the non-target operating system to control the peripheral apparatus to perform the corresponding operation according to the received processing result. In this way, flexibility of the electronic device in processing the target event is improved, and the processing efficiency of processing the target event is improved.

In an embodiment, the processing unit is configured to configure the control authority of the peripheral apparatus of the electronic device to the target operating system, causing the target operating system to take the peripheral apparatus to process the target event.

According to the above-mentioned apparatus, the control authority of the peripheral apparatus of the electronic device may be switched to the target operating system to enable the target operating system to take the peripheral apparatus to assist in processing the target event. In this way, the processing effect and the processing efficiency of the target event are improved.

Furthermore, the control instruction that is sent by the target operating system to the peripheral apparatus, is prevented from conflicting with the control instruction sent from other operating systems, ensuring the electronic device to operate normally.

In an embodiment, in response to the non-target operating system being in the running state and having the control authority of the peripheral apparatus, the processing unit is configured to send, via the target operating system, the switching instruction to the non-target operating system, enabling the non-target operating system to switch the control authority of the peripheral apparatus to the target operating system according to the switching instruction. The non-target operating system is one of the first operating system and the second operating system, other than the target operating system.

According to the above-mentioned apparatus, the control authority of the peripheral apparatus of the electronic device can be switched to the target operating system to enable the target operating system to take the peripheral apparatus to assist in processing the target event, such that the processing effect and the processing efficiency of the target event are improved. Furthermore, the control instruction that is sent by the target operating system to the peripheral apparatus is prevented from conflicting with the control instruction sent by other operating systems, ensuring the electronic device to operate normally.

In an embodiment, the apparatus shown in FIG. 8 further includes a peripheral control unit, which is not shown in the drawing.

After switching the control authority of the peripheral apparatus of the electronic device to the target operating system, the peripheral control unit is configured to receive, by the peripheral apparatus, the input target operation and to process, by the target operating system, the target operation.

Alternatively, the peripheral control unit is configured to control, by the target operating system based on the processing result, the peripheral apparatus to perform a corresponding operation. The processing result is a result obtained by the target operating system processing the target event.

According to the above-described apparatus, after having the control authority of the peripheral apparatus, the electronic device may receive the operation input from the user or output the processing result through the peripheral apparatus, such that the target operating system may improve, with the assistance of the peripheral apparatus, the processing effect and the processing efficiency of the target event.

In an embodiment, the apparatus shown in FIG. 8 further includes a second configuration unit, which is not shown in the drawing.

After controlling the target operating system corresponding to the target wake-up module to switch from the sleeping state to the running state based on the wake-up signal, and in response to determining that the target operating system is satisfied with the switching to the sleeping state, the second configuration unit is configured to determine, through the target operating system, at least one shared module configured from all shared modules included in the electronic device to be configured as the wake-up module corresponding to the target operating system; and configured to control the target operating system to switch to the sleeping state.

According to the above-described apparatus, at least one hardware module is determined from all hardware modules included in the electronic device to be configured as the wake-up module corresponding to the target operating system. The wake-up signal generated by the wake-up module is used to wake up only the target operating system. In this way, conflicts, due to the wake-up signal generated by the wake-up module waking up the plurality of operating systems at the same time, may be prevented. In addition, controllability and flexibility of the control of waking up of the operating system may be improved.

In an embodiment, the second configuration unit is configured to determine at least one shared module from all hardware modules included in the electronic device, and configure the at least one shared module as the to-be-effected wake-up module for the target operating system. The second configuration unit is configured to determine, in response to the to-be-effected wake-up module being determined as being in the idle state, the to-be-effected wake-up module to be effective. The effective wake-up module is configured to generate the wake-up signal to cause the target operating system to switch from the sleeping state to the running state based on the wake-up signal.

According to the above-described apparatus, the target operating system may configure the wake-up module when the target operating system is about to enter the sleeping state, and determine that the configuration is effective only when the configured wake-up module is determined as being in the idle state. In this way, the function that is currently executed by the to-be-effected wake-up module is prevented from conflicting with the wake-up function, and the target operating system is prevented from being mistakenly woken up.

In an embodiment, the second configuration unit is further configured to configure all shared modules included in the electronic device to be wake-up modules corresponding to the target operating system in response to the electronic device being operating in the first operation mode and the target operating system being the second operating system.

According to the above-described apparatus, when the electronic device is in the low-power-consumption mode, all hardware modules are configured as wake-up modules of the operating system that has the low operating power consumption. When any wake-up module thereof generates the wake-up signal, the operating system that has the low operating power consumption can be woken up to process the target event, such that the requirements of the electronic device running at the power operating power consumption are met.

In an embodiment, the second configuration unit is further configured to configure all shared modules included in the electronic device as the wake-up modules corresponding to the target operating system, when the electronic device is currently in the second operating mode and the target operating system is the first operating system. The operating power consumption of the electronic device is low when the electronic device is in the first operating mode, the operating power consumption of the first operating mode is less than the operating power consumption of the second operating mode.

According to the above-described apparatus, when the electronic device is in the high-performance mode, all hardware modules are configured as wake-up modules for the operating system having the high performance. When any wake-up module thereof generates the wake-up signal, the operating system having the high performance can be woken up to process the target event, such that the requirements of the electronic device running at the high performance are met.

As shown in FIG. 9, FIG. 9 is a structural schematic view of an electronic device according to an embodiment of the present disclosure. As shown in FIG. 9, the electronic device may include following structure.

A memory 901 is arranged and stores executable program codes.

A processor 902 is coupled to the memory 901.

The processor 902 invokes the executable program codes stored in the memory 901 to perform the method of waking up the operating system disclosed in the above embodiments.

Embodiments of the present application provide a computer-readable storage medium storing a computer program. The computer program causes the computer to perform the method of waking up the operating system as disclosed in the above embodiments.

Embodiments of the present application further provide an application releasing platform. The application releasing platform is used to release a computer program product. The computer program product, when running on a computer, causes the computer to perform some or all of the operations of the method as disclosed in the above embodiments.

It is understood that references to “one embodiment” or “an embodiment” in the specification imply that a particular feature, a structure, or a property in an embodiment is included in at least one embodiment of the present disclosure. Therefore, “in an embodiment” or “in one embodiment” appearing at various sections of the specification may not necessarily refer to the same embodiment. Furthermore, the particular feature, the structure or the property may be combined from one or more embodiments in any suitable manner. Any ordinary skilled person in the art shall be aware that the embodiments described in the specification are optional embodiments, and the operations and modules involved therein may not bee necessary for the present disclosure.

In various embodiments of the present disclosure, it is understood that magnitude of serial numbers of the above processes does not imply an inevitable sequence of execution, and the sequence of execution of the processes shall be determined based on functions and inherent logic without having any limitation in implementing the embodiments of the present disclosure.

The units illustrated above as separated parts may or may not be physically separated from each other, and the parts shown as units may or may not be physical units, i.e., the units may be located at one place or may be distributed to a plurality of network units. Some or all of the units may be selected to achieve the purpose of the embodiments according to actual demands.

In addition, various functional units in the embodiments of the present disclosure may be integrated in one processing unit, or each unit may physically exist independently, or two or more units may be integrated in one unit. The above integrated units may be realized either in the form of hardware or in the form of software functional units.

The above integrated units may be stored in a computer-accessible memory when realized as software functional units and sold or used as stand-alone products. Based on this understanding, the technical solution of the present disclosure, or portions that contribute to the prior art, or all or portions of the technical solution, may be embodied in the form of a software product, which is stored in a memory, including a number of requests for making a computer device (which may be a personal computer, a server, or a network device, and so on, and in particular may be a processor in the computer device) perform some or all of the methods of the various embodiments of the present disclosure.

Any ordinary skilled person in the art may understand that all or some of the operations in the various methods of the above embodiments are accomplishable by a program to instruct the associated hardware, and the program may be stored in a computer-readable storage medium. The storage medium includes a read-only memory (ROM), a random access memory (RAM), a programmable read-only memory (PROM), an erasable programmable read-only memory (EPROM), an one-time programmable read-only memory (OTPROM), an electrically-erasable programmable read-only memory (EEPROM), a compact disc read-only memory (CD-ROM), or other optical disk memories, magnetic disk memories, magnetic tape memories, or any other medium capable of being used to carry or store data in a computer-readable manner.

In the above, the method and the apparatus of waking up the operating system, the electronic device, and the storage medium are disclosed in the embodiments of the present disclosure. Specific examples are applied herein to illustrate principles and implementation of the present disclosure, and the above description of the embodiments is only used to understand the method of the present disclosure and core concepts thereof. Any ordinary skilled person in the art may perform changes in the specific implementation based on the concepts of the present disclosure. In summary, contents of the specification shall not be interpreted as a limitation of the present disclosure.

What is claimed is:

1. A method of waking up an operating system, performed by an electronic device, the electronic device being configured to run a first operating system and a second operating system, the method comprising:
in a case that the first operating system and/or the second operating system is in a sleeping state, controlling, by the electronic device, a target operating system corresponding to a target wake-up module to switch from the sleeping state to a running state based on a wake-up signal, wherein, the wake-up signal is generated by the target wake-up module.

2. The method according to claim 1, wherein, after controlling, by the electronic device, the target operating system corresponding to the target wake-up module to switch from the sleeping state to the running state based on the wake-up signal, the method further comprises:
processing, by the target operating system, a target event corresponding to the wake-up signal.

3. The method according to claim 2, wherein processing, by the target operating system, the target event corresponding to the wake-up signal, comprises:
determining, by the target operating system, a sub-module and/or a non-target operating system required to process the target event corresponding to the wake-up signal; wherein, the non-target operating system is one of the first operating system and the second operating system, other than the target operating system; and
sending, by the target operating system, the target event to the sub-module and/or the non-target operating system to cause the sub-module and/or the non-target operating system to process the target event.

4. The method according to claim 3, wherein after determining, by the target operating system, the sub-module and/or the non-target operating system required to process the target event corresponding to the wake-up signal, the method further comprises:
sending, by the target operating system, a running instruction to the non-target operating system to cause the non-target operating system to switch from the sleeping state to the running state, in response to the target event needing to be processed by the non-target operating system and the non-target operating system being in the sleeping state.

5. The method according to claim 3, wherein, after sending, by the target operating system, the target event to the sub-module and/or the non-target operating system to cause the sub-module and/or the non-target operating system to process the target event, the method further comprises:
in response to determining that the non-target operating system is satisfied with the switching to the sleeping state, determining, by the non-target operating system, at least one shared module from all shared modules comprised in the electronic device to be configured as a wake-up module corresponding to the non-target operating system; and controlling the non-target operating system to switch to the sleeping state; wherein, the shared module is a module capable of being configured as the wake-up module for the first operating system or the second operating system.

6. The method according to claim 2, wherein, after processing, by the target operating system, the target event corresponding to the wake-up signal, the method further comprises:
in response to a non-target operating system being in the running state and having a control authority for a peripheral apparatus, sending, by the target operating system, a peripheral control instruction to the non-target operating system to cause the non-target operating system to control the peripheral apparatus to perform a corresponding operation based on the peripheral control instruction; wherein, the peripheral control instruction is obtained by the target operating system processing the target event, and the non-target operating system is one of the first operating system and the second operating system, other than the target operating system.

7. The method according to claim 2, wherein processing, by the target operating system, the target event corresponding to the wake-up signal, comprises:
configuring a control authority of a peripheral apparatus of the electronic device to the target operating system to cause the target operating system to take the peripheral apparatus to process the target event.

8. The method according to claim 7, wherein, after configuring the control authority of the peripheral apparatus of the electronic device to the target operating system, the method comprises:
receiving, through the peripheral apparatus, an input target operation and processing, by the target operating system, the target operation; or
controlling, by the target operating system based on a processing result, the peripheral apparatus to perform a corresponding operation; wherein the processing result is a result obtained by the target operating system processing the target event;
and/or
receiving, by the target operating system, a second processing result and controlling the peripheral apparatus to perform a corresponding operation according to the second processing result; wherein the second processing result is a result obtained by a non-target operating system processing the target event; and the non-target operating system is one of the first operating system and the second operating system, other than the target operating system.

9. The method according to claim 1, wherein,
the target operating system is determined, by the electronic device, from the first operating system and the second operating system according to a matching rule, wherein the matching rule comprises an operating system corresponding to each wake-up module; and/or
the target operating system is determined based on a system selection instruction input from a user, the system selection instruction comprises the first operating system or the second operating system.

10. The method according to claim 1, wherein,
an operating power consumption of the second operating system is less than an operating power consumption of the first operating system; the method comprises: configuring, by the target operating system, all shared modules or all hardware modules comprised in the electronic device to be wake-up modules corresponding to the target operating system, when the electronic device is operating in a low-power-consumption mode and the target operating system is the second operating system; and/or
an operating performance of the first operating system is higher than an operating performance of the second operating system; the method comprises: configuring all hardware modules comprised in the electronic device to be wake-up modules corresponding to the target operating system, when the electronic device is operating in a high-performance mode and the target operating system is the first operating system.

11. The method according to claim 1, wherein, after controlling, by the electronic device, the target operating system corresponding to the target wake-up module to switch from the sleeping state to the running state based on the wake-up signal, the method comprises:
in response to determining that the target operating system is satisfied with switching to the sleeping state, determining, by the target operating system, at least one shared module configured from all shared modules comprised in the electronic device to be configured as the wake-up module corresponding to the target operating system; and controlling the target operating system to switch to the sleeping state;
wherein, the shared module is a module capable of being configured as the wake-up module for the first operating system or for the second operating system.

12. The method according to claim 11, wherein, before determining, by the target operating system, at least one shared module configured from all shared modules comprised in the electronic device to be configured as the wake-up module corresponding to the target operating system, in response to determining that the target operating system is satisfied with switching to the sleeping state, the method further comprises:
determining that the target operating system is satisfied with switching to the sleeping state in response to the target operating system being determined as being in an idle state for a second time length; wherein, the idle state is a state in which the target operating system is not processing a target event.

13. The method according to claim 11, wherein, before determining, by the target operating system, at least one shared module configured from all shared modules comprised in the electronic device to be configured as the wake-up module corresponding to the target operating system, in response to determining that the target operating system is satisfied with switching to the sleeping state, the method further comprises:
in response to determining that any second associated module associated with the target operating system is in a non-operating state, determining that the target operating system is satisfied with switching to the sleeping state; wherein the second associated module is a module needing to be controlled by the target operating system, and the non-operating state comprises the sleeping state and a shutdown state.

14. The method according to claim 11, wherein, determining, by the target operating system, at least one shared module configured from all shared modules comprised in the electronic device to be configured as the wake-up module corresponding to the target operating system, comprises:
determining at least one shared module, from all shared modules comprised in the electronic device, to be configured as a to-be-effected wake-up module for the target operating system; and
determining the to-be-effected wake-up module to be effective in response to the to-be-effected wake-up module being determined as in an idle state, wherein the effective wake-up module is configured to generate the wake-up signal to cause the target operating system to switch from the sleeping state to the running state based on the wake-up signal.

15. The method according to claim 14, wherein, after determining at least one shared module, from all shared modules comprised in the electronic device, to be configured as a to-be-effected wake-up module for the target operating system, the method comprises:
in response to determining that both the target operating system and the non-target operating system are in the sleeping state, determining the to-be-effected wake-up module to be effective.

16. The method according to claim 11, wherein, the operating power consumption of the second operating system is less than the operating power consumption of the first operating system; and the determining, by the target operating system, at least one shared module configured from all shared modules comprised in the electronic device to be configured as the wake-up module corresponding to the target operating system, comprises:
in response to the electronic device being currently in a first operating mode and the target operating system being the second operating system, configuring, by the target operating system, all shared modules comprised in the electronic device to be wake-up modules corresponding to the target operating system.

17. The method according to claim 16, further comprising:
in response to the electronic device being currently in a second operating mode and the target operating system being the first operating system, configuring, by the target operating system, the shared modules comprised in the electronic device as the wake-up modules corresponding to the target operating system; wherein, an operating power consumption of the electronic device when operating in the first operating mode is less than the an power consumption of the electronic device when operating in the second operating mode.

18. An electronic device, comprising: a memory storing executable program codes, and a processor coupled to the memory; wherein the processor is configured to invoke the executable program codes stored in the memory to perform operations of:
in a case that a first operating system and/or a second operating system of the electronic device is in a sleeping state, controlling a target operating system corresponding to a target wake-up module to switch from the sleeping state to a running state based on a wake-up signal; wherein the wake-up signal is generated by the target wake-up module.

19. The electronic device according to claim 18, wherein, the processor is further configured to invoke the executable program codes stored in the memory to perform operations of:
determining at least one shared module, from all shared modules comprised in the electronic device, to be configured as a to-be-effected wake-up module for the target operating system; and
determining the to-be-effected wake-up module to be effective in response to the to-be-effected wake-up module being determined as in an idle state, wherein the effective wake-up module is configured to generate the wake-up signal to cause the target operating system to switch from the sleeping state to the running state based on the wake-up signal.

20. A computer readable storage medium, storing a computer program, wherein the computer program, when being executed by a processor, is configured to perform operations of:
in a case that a first operating system and/or a second operating system of the electronic device is in a sleeping state, controlling a target operating system corresponding to a target wake-up module to switch from the sleeping state to a running state based on a wake-up signal; wherein the wake-up signal is generated by the target wake-up module.
